(19) United States
(12) Patent Application Publication
(10) Pub. No.: US 2011/0025094 A1
(43) Pub. Date: Feb. 3, 2011

(54) LIGHTWEIGHT COMPONENT FOR A VEHICLE BODY

(75) Inventor: Konrad Eipper, Rottenburg (DE)

Correspondence Address: PATENT CENTRAL LLC;Stephan A. Pendorf, 1401 Hollywood Boulevard, Hollywood, FL, 33020, US

(73) Assignee: DAIMLER AG, Stuttgart (DE)

(21) Appl. No.: 12/935,088

(22) PCT Filed: Mar. 17, 2009
(86) PCT No.: PCT/EP2009/001973

§ 371 Date: Sep. 28, 2010

(30) Foreign Application Priority Data
Apr. 9, 2008 (DE) 10 2008 017 977.9

(51) Int. Cl. B62D 29/00; B22D 19/04

(52) U.S. Cl. 296/187.01; 29/527.5

(57) ABSTRACT

The invention relates to a lightweight component for a vehicle body, which forms at least one closed frame. The lateral parts of the frame are designed as cast components and joined by at least one reinforcement profile disposed between the lateral parts, the end regions of the reinforcement profile being cast around by the cast components with a positive and adhesive connection. The invention further relates to a method for the production of such lightweight components.

The invention relates to a lightweight component for a vehicle body according to the preamble of patent claim 1.

For the construction of vehicle bodies in particular, profiled structures are often selected, wherein the individual components are joined by cast nodes. The joints between the profiled components and the cast nodes are as a rule produced using common joining methods such as adhesive-bonding or welding.

This has several disadvantages. On the one hand, the individual components have to be provided with joining surfaces which may be difficult to produce. On the other hand, the joining method used invariably affects the strength and the material properties in the region of the joining zones. In welded joints, for example, so-called heat-affected zones are created, where the lattice structure of the welded metal parts is changed, which generally results in increased material stresses. This in turn may reduce material strength. In addition, the achievable manufacturing tolerances are as a rule limited by the joining method used. Finally, the assembly of body parts from a plurality of profiled and cast elements involves the disadvantage of high costs in terms of process engineering.

From DE 199 31 741 A1, a lightweight vehicle body is known, wherein shaped pockets are provided in the castings of a body part, in which the profiled components of the body can then be located.

The present invention is therefore based on the problem of providing a lightweight component for a vehicle body, which uses the advantages of a lightweight construction comprising cast nodes and profiled elements while avoiding the disadvantageous effects prevailing in the joining of the cast and profiled elements.

This problem is solved by a lightweight component with the features of patent claim 1.

The lightweight component for a vehicle body according to the invention forms a closed frame comprising lateral parts designed as cast components and at least one reinforcement profile or component arranged between the lateral parts, the opposite ends of the reinforcement profile being cast into the lateral parts on at least one side.

A component of this type, for example a door support frame, a support frame for a tailgate, engine cover or roof, can be produced in a single operation by casting around the previously provided profiled or sheet metal components. Depending on the structural task, the components to be cast in may have a profiled or sheet metal construction, forming profiled or sheet metal reinforcement parts. There is no longer any need for complex joining surfaces, as an adhesive and positive connection between the individual components is obtained by casting around. Owing to the large-surface heat transmission between the melt and the profiled component in the casting-around process, the formation of heat-affected zones and the material stresses to which other joining methods are subject are avoided. The pre-positioning of the profiled components in corresponding recesses in the casting mould further promotes a positionally accurate production of the component with tighter tolerances than in prior art production methods.

In a preferred embodiment, at least one profiled component is disposed as a crossmember or side member in the lightweight component according to the invention. This results in a particularly advantageous power transmission in unitised body parts.

In a further embodiment of the invention, at least one reinforcement profile extends at an angle between the crossmembers or side members of the lightweight component. Such inclined profiles advantageously increase the crash safety of body parts by deflecting any forces generated by the impact of an object on such a component towards the laterally disposed cast nodes.

In an alternative embodiment, the cast component is produced in a single piece, wherein both lateral parts and at least one cross-connection between the lateral parts are cast in a single cavity of a casting mould. For the further reinforcement of the body part, at least one further cross-connection in the form of a reinforcement profile or plate is provided, its end regions being cast into the cast lateral parts. The single-piece design of the cast component results in a particularly stable construction by further reducing the number of joining zones and thus material stresses. In addition, the production of such a component is particularly simple, because there is no need for complex casting moulds with several cavities.

In an alternative embodiment, the cast portion of the lightweight component is designed in two parts, wherein only the lateral parts of the component are cast and joined to each other by at least two reinforcement profiles. The higher complexity of using a casting mould with at least two cavities is advantageously compensated by the finished lightweight component offering advantages in terms of weight.

In a preferred embodiment, the lightweight component is designed as a door support frame, wherein the top-located window frame is represented by a reinforcement profile, while the rest of the frame forms a single-piece casting. This design offers an advantageous compromise between high mechanical strength in highly stressed regions and low material weight in regions subjected to lower stresses.

In an alternative embodiment, the lightweight component is designed as a door frame with two separately cast lateral parts joined by three reinforcement profiles. In cases of lateral impact, in particular, this arrangement ensures an advantageous deflection of the acting forces to the pillar-side castings via the profiled components.

In a further embodiment, the lightweight component is designed as a door support frame, wherein two lateral castings are joined by three profiled components designed as cross-connections and wherein at least one further reinforcement profile is disposed at an angle between the lower and middle profiled components. This advantageously provides further protection in a lateral impact.

In a particularly preferred embodiment, the cast portion of the frame is an aluminum or magnesium die-cast component. This achieves a particularly advantageous compromise between material weight and mechanical material properties.

In a further preferred embodiment, the reinforcement profiles are designed as extruded or cast profiles produced from an aluminum or magnesium alloy. This variant combines simple manufacturing processes with low weight and optimum properties of the joint region, as the reinforcement profiles are essentially made of the same material as the castings.

In an alternative embodiment, the reinforcement profiles may be made of profiled sheet steel or of a steel casting. In this embodiment, a higher weight of the reinforcement profiles is tolerated in order to achieve higher strength, for example in mechanically critical regions.

In a particularly preferred embodiment, the lightweight component is designed as a frame component provided with joining surfaces for attaching a cladding of light alloy, sheet steel or plastic. This allows for a single-step mounting of, for example, an external cladding of a body part on a previously provided frame in a very simple process.

To produce a body part according to the invention, an inventive method according to patent claim 1 is used. In this method, at least one reinforcement profile is placed in a casting mould for a lightweight component in such a way that the end regions of the reinforcement profile project into the cavities of the mould and the melt is cast around them. As a result of the pre-positioning of the at least one reinforcement profile in the casting mould, particularly good manufacturing tolerances are achieved. The resulting positive and adhesive connection between the cast portion of the component according to the invention and the reinforcement profile further offers particularly good material properties, in particular very low material stresses, owing to the large-surface heat transmission between the casting material and the profiled component.

In a particularly preferred embodiment of the method, an aluminum or magnesium die-casting alloy is used in the die-casting process. These methods allow the production of very thin-walled but nevertheless dimensionally stable castings.

In a further embodiment of the method, a casting mould with only one cavity is used, so that the lateral parts and at least one transversely oriented connecting part of the lightweight component are cast in one piece. This simplifies the casting process compared to a two-piece design of the cast portion of the lightweight component, as only one cavity and therefore only one gate system has to be provided.

In a further variant of the method, the middle part of the reinforcement profile lying between the end pieces is at least partially cast in. This allows for a more complex component geometry and makes the production of particularly stable lightweight components accessible to the method.

Advantageous embodiments of lightweight components according to the invention are described below with reference to the accompanying drawings, of which:

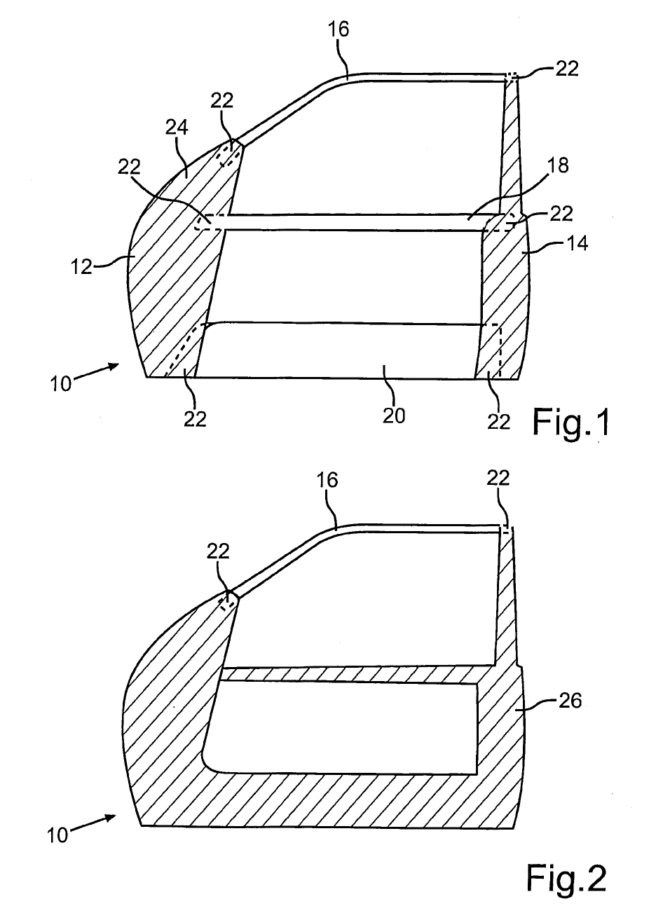

FIGS. 1 to 4 are side views of lightweight components according to the invention which are designed as a motor vehicle door;

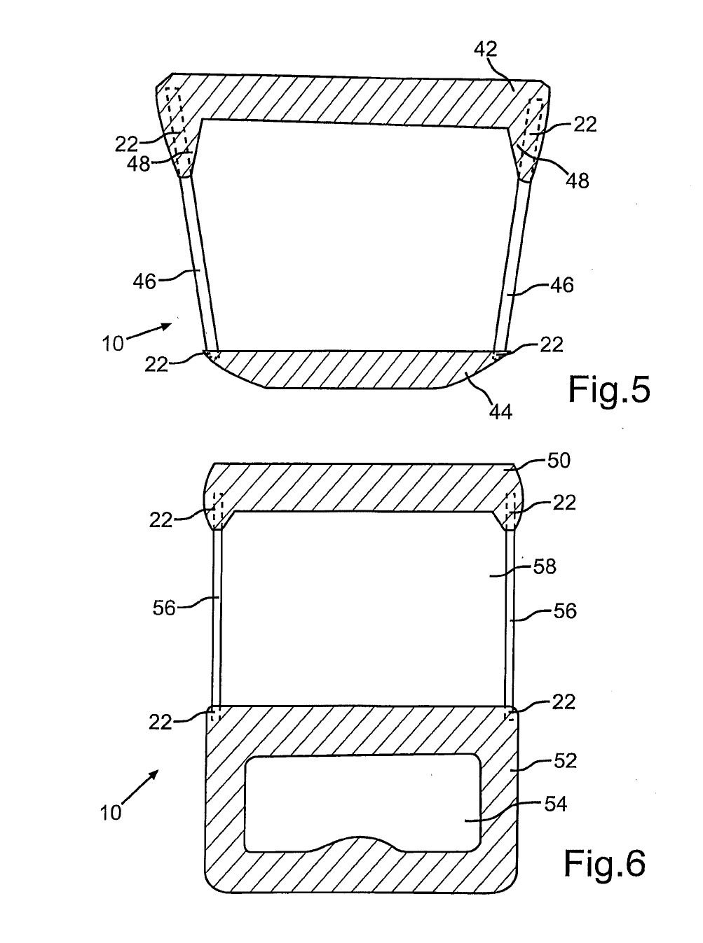

FIG. 5 shows a support structure according to the invention for an engine cover or a tailgate;

FIG. 6 is a diagrammatic side view of a tailgate designed according to the invention.

FIG. 1 is a diagrammatic side view of a door support represented by a lightweight component according to the invention. The door support generally identified by the number 10 comprises two lateral parts 12 and 14 designed as cast components, the lateral part 12 of the finished door being located on the A-pillar of the motor vehicle via a swivel element, while the lateral part 14 overlaps the B-pillar of the motor vehicle in the assembled state. The lateral parts 12 and 14 are joined to each other by reinforcement profiles, an upper reinforcement profile 16 extending in the region of the upper edge of the window, while a middle reinforcement profile 18 joins the lateral parts 12 and 14 at the level of the side board edge and a lower reinforcement profile 20 extends in the longitudinal direction of the door support at the level of the lower edge of the door. The end regions 22 of the reinforcement profiles 16, 18, 20 are embedded in the cast components 12 and 14 and adhesively and positively joined thereto. The cast components 12 and 14 extend beyond the region of the side board edge, and the cast component 12 in particular includes the region of the mirror triangle.

The cast components 12 and 14 are designed such that they provide fastening devices for further components of the vehicle door. In particular, joining flanges not shown in the drawing are provided for attaching an external cladding and an inner lining. The cast component 12 oriented towards the A-pillar of the vehicle is further provided with a location for the door-side part of a hinge.

FIG. 2 shows an alternative embodiment of a door support according to the invention. In this embodiment, both the lateral regions and the cross-bracing extending along the lower edge of the door and at the level of the side board edge are designed as a single-piece cast component 26. A reinforcement profile 16 joins the upper end regions of the lateral parts at the level of the upper edge of the door, its end regions 22 being cast into the cast component 26.

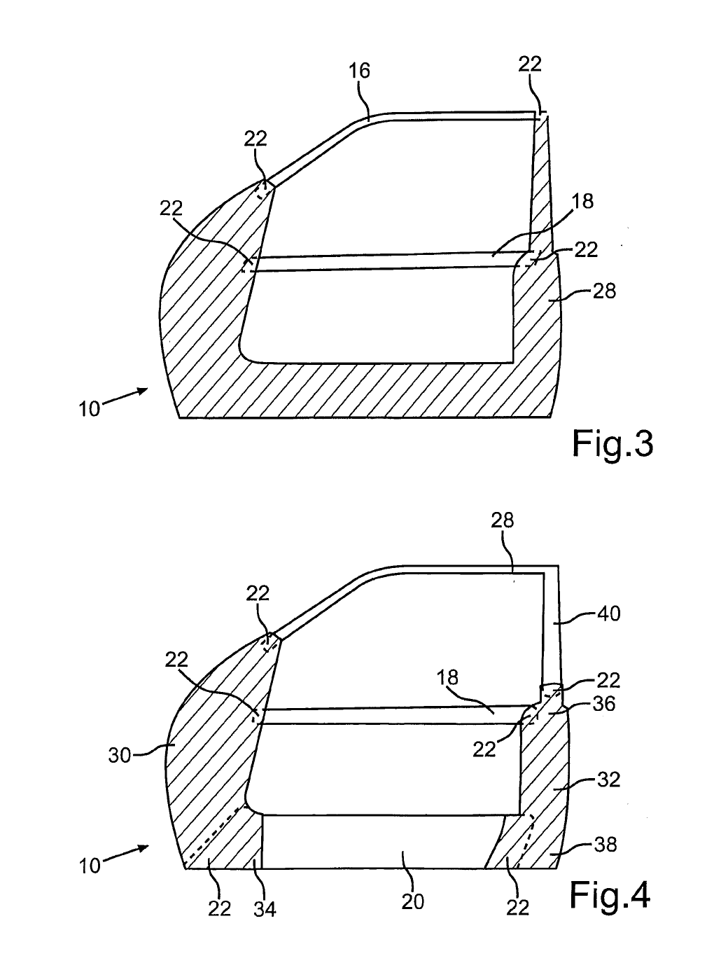

FIG. 3 shows an embodiment of a door support in which the two lateral parts and the cross-bracing extending along the lower edge of the door are once again designed as a single-piece cast component 28. At the level of the upper edge of the door and at the level of the side board edge, further cross-bracings 16 and 18 designed as reinforcement profiles are provided, their end regions 22 being cast into the cast component 28.

FIG. 4 shows a further embodiment of a door support in which the lateral parts are represented by separate cast components. The cast component 30 oriented towards the A-pillar is slightly angled, its lower region 34 forming a part of the cross-bracing extending along the lower edge of the door. The cast component 32 oriented towards the B-pillar projects only slightly beyond the side board edge in its upper region 36, while the lower region 38 of the cast component 32 is once again angled and forms a part of the cross-bracing extending along the lower edge of the door. The end regions 22 of a reinforcement profile 20 are cast into the lower regions 34, 38 of the cast components 30, 32, completing the cross-bracing extending along the lower edge of the door. Two further reinforcement profiles 18, 28 join the lateral parts 30 and 32 at the level of the side board edge or the upper edge of the window respectively. The reinforcement profile 28 extending along the upper edge of the window is angled, a vertical section 40 forming part of the lateral part oriented towards the B-pillar. The end region 22 of the vertical section 40 is cast into the upper region 36 of the cast component 32.

If the cast components are separate, one or both of them may generally be provided with cast-in profiled or sheet metal parts.

FIG. 5 shows a lightweight component according to the invention which forms a support frame structure for an engine cover. Two cast components 42 and 44 are joined by longitudinally oriented reinforcement profiles 46, the end regions 22 of the reinforcement profiles 46 being cast around by the cast components 42 and 44 with adhesive and positive connection. The hinge-side cast component 42 of the engine cover support is further provided with projections 48 enclosing a further region of the reinforcement profiles 46 for further stabilisation. The cast components 42 and 44 are provided with fasteners not shown in the drawing, in particular with joining flanges for the external cladding of the engine cover or tailgate, and with fastening devices for a reinforcing internal structure thereof. The hinge-side cast component 42 is further provided with locations for the engine cover hinges, while the cast component 44 oriented towards the vehicle front is provided with the corresponding fasteners for an engine cover lock.

FIG. 6 shows an embodiment of a lightweight component according to the invention which is designed as a tailgate frame. It comprises two cast components 50 and 52, the cast component 52 itself forming a closed frame enclosing a cut-out 54. The cast components 50 and 52 are joined by reinforcement profiles 56 extending in the longitudinal direction, the end regions 22 of which are cast around by the cast components 50 and 52 with adhesive and positive connection. The components surround a cut-out 58 for the accommodation of a tailgate window. In addition to the fasteners provided for external cladding, inner lining, tailgate hinges and tailgate lock, this arrangement features sealing flanges oriented towards the cut-out for the sealed installation of a rear window.

Further applications for lightweight components according to the invention, such as roof support frames, vehicle rear doors or windowless tailgates, will be obvious to any expert in vehicle body construction.

1. A lightweight component for a body or a body part of a motor vehicle, the lightweight component forming a closed frame and comprising lateral parts (12, 14) which are at least partially designed as cast components and at least one reinforcement profile or reinforcement plate (16, 18, 20) disposed between these lateral parts, wherein the opposite end regions (22) of the reinforcement profile or plate (16, 18, 20) are materially and form-fittingly connected to at least one lateral part (12, 14) by casting around.

2. The lightweight component (10) according to claim 1, wherein at least one reinforcement profile or plate (16, 18, 20) forms a crossmember or a side member with respect to the vehicle body.

3. The lightweight component (10) according to claim 2, wherein at least one further reinforcement profile or plate extends at an angle between the crossmembers or side members respectively.

4. The lightweight component (10) according to claim 1, wherein the lateral parts (26) and at least one cross-connection between the lateral parts are cast as a single piece.

5. The lightweight component (10) according to claim 1, wherein two lateral parts (12, 14) cast separately are joined to each other by a plurality of reinforcement profiles or plates (16, 18, 20).

6. The lightweight component (10) according to claim 1, wherein the lightweight component (10) is designed as a door support frame, the crossmember extending in the proximity of the upper edge of the window being designed as a reinforcement profile or plate (16).

7. The lightweight component (10) according to claim 6, wherein two cast lateral parts (12, 14) are joined by a reinforcement profile or plate (20) extending at the level of the lower edge of the door, a reinforcement profile or plate (18) extending at the level of the side board edge and a reinforcement profile (16) extending near the upper edge of the window.

8. The lightweight component (10) according to claim 6, wherein a further reinforcement profile or plate extends at an angle between a lower and a middle crossmember.

9. The lightweight component (10) according to claim 1, wherein the cast portion of the lightweight component is made of an aluminum or magnesium die-casting alloy.

10. The lightweight component (10) according to claim 1, wherein the reinforcement profiles or plates (16, 18, 20) are produced as extruded or cast sections from an aluminum or magnesium die-casting alloy.

11. The lightweight component (10) according to claim 1, wherein the reinforcement profiles or plates (16, 18, 20) are produced as profiled sheet steel components or cast steel profiles.

12. The lightweight component (10) according to claim 1, wherein the lightweight component is designed as a support frame to which a cladding of light alloy, sheet steel or plastic can be attached by means of joining surfaces.

13. A method for the production of lightweight components (10) for a body of a motor vehicle, wherein the lightweight components (10) comprise at least one closed frame with at least two lateral parts, comprising the following steps:
the provision of at least one profiled or sheet-metal reinforcement part made of a light alloy or steel,
the placing of the at least one reinforcement part in a casting mould having at least one cavity for the cast portion of the lightweight component, so that the end regions (22) of the at least one reinforcement part project into the at least one cavity of the casting mould,
the encapsulation with a light alloy, so that the end regions (22) of the at least one reinforcement part are cast into the lateral parts to form a form-fitting and material connection.

14. The method according to claim 13, wherein a die-casting process using an aluminum or magnesium die-casting alloy is used for encapsulation.

15. The method according to claim 13, wherein the lateral parts of a lightweight component (10) and a crossmember or side member element joining the lateral parts are cast as a single piece.

16. The method according to claim 13, wherein a middle part of the reinforcement part located between the end pieces (22) is at least partially cast around.
